(19) United States
(12) Patent Application Publication
(10) Pub. No.: US 2025/0309594 A1
(43) Pub. Date: Oct. 2, 2025

(54) DUAL POWER INLET FOR PORTABLE GENERATOR

(71) Applicant: Imperial Industrial Supply Co., Ontario, CA (US)

(72) Inventor: Robert Johnson, Ontario, CA (US)

(73) Assignee: Imperial Industrial Supply Co., Ontario, CA (US)

(21) Appl. No.: 19/089,710

(22) Filed: Mar. 25, 2025

Related U.S. Application Data
(60) Provisional application No. 63/569,773, filed on Mar. 26, 2024.

(51) Int. Cl. H01R 25/00; H01R 9/24; H01R 13/213; H01R 13/68; H01R 13/713; H01R 24/00; H01R 24/22; H01R 105/00

(52) U.S. Cl. CPC H01R 25/006; H01R 9/2433; H01R 13/213; H01R 13/68; H01R 13/713; H01R 24/005; H01R 24/22; H01R 2105/00; H01R 2201/10

(57) ABSTRACT

A dual power inlet for portable generators addresses the challenge of safely recombining split power outputs from generators. This apparatus is designed for home power backup, utilizing readily available power cords and provides a practical solution for safely harnessing the full power capacity of large portable generators. The dual power inlet features a first twist lock receptacle and a second twist lock receptacle for receiving two 50 A circuits, each connected to a three-pole relay to prevent reverse current flow. A terminal block combines these circuits into a single output. A 220/240 V coil relay ensures proper phasing by actuating only with a combined 240 V, preventing short circuits. The system includes a ground block for safety and can interface with a home electrical panel via either an interlock or transfer switch.

### FIELD OF THE INVENTION

The invention relates to a power inlet to safely re-combine the split power output from a portable electric generator.

### BACKGROUND

Portable generators for home power backup have progressively gotten larger, with increased power output. Currently, there are a number of commercially available portable generators that have an output of over 50 amps. Typically, the output for such generators has been divided into two 50-amp outlets. This results in an issue of being able to utilize all of the power that a larger generator can produce.

There therefore exists a need for an improved power inlet to safely re-combine the split power output from a portable electric generator.

### BRIEF DESCRIPTION OF THE DRAWINGS

A more complete understanding of the present disclosure, and the attendant advantages and features thereof, will be more readily understood by reference to the following description when considered in conjunction with the accompanying drawings wherein:

FIG. 1 shows an embodiment of a circuit layout of a dual power inlet according to the invention.

FIG. 2 shows an embodiment of a dual power inlet according to the invention with the cover removed.

FIG. 3 shows a cover of a dual power inlet according to the invention.

FIG. 4 shows the dual power inlet of FIG. 3 with the cover removed.

FIG. 5 shows another embodiment of a dual power inlet according to the invention.

FIG. 6 shows an embodiment of a dual power inlet according to the invention coupled to a portable generator and a transfer switch.

### SUMMARY OF THE INVENTION

One aspect of the invention relates to an apparatus for safely recombining split power output from a portable electric generator. The apparatus comprises: a first receptacle configured to receive a first power cord delivering a first electrical power from a first output of the portable electric generator; a second receptacle configured to receive a second power cord delivering a second electrical power from a second output of the portable electric generator; a first three-pole relay electrically coupled to the first receptacle for preventing reverse current flow; a second three-pole relay electrically coupled to the second receptacle for preventing reverse current flow; a terminal block electrically connected to the first and second three-pole relays for combining the first and second electrical power from the first and second power cords to provide a combined electrical power output equal to a sum of the first and second electrical power; and a 220/240 V coil relay electrically connected to the first and second receptacles via respective hot wires, the 220/240 V coil relay being configured to actuate only upon receiving a combined voltage of 240 V when the hot wires are appropriately phased. The combined electrical power output flows through the terminal block when the 220/240 V coil relay is actuated and only one of the first and second electrical power flows through the terminal block when 220/240 V coil relay is not actuated.

In an exemplary embodiment, the first and second receptacles are twist lock receptacles. Further, the first electrical load is a 50 A circuit and the second electrical load is a 50 A circuit so that the combined electrical power output is a 100 A power output.

The apparatus can further comprise a ground block configured for providing proper grounding for the apparatus with a breaker interlock or a transfer switch operatively coupled between the terminal block and a house power panel. Preferably, a default state of each of the first and second three-pole relays and the 220/240 V coil relay is open.

For added safety, at least one of the first and second three-pole relays can include a circuit breaker or fuse.

Another aspect of the invention relates to a method for safely recombining split power output from a portable generator. The method comprises: receiving a first circuit from a first power cord connected to a first output of the generator via a first receptacle; receiving a second circuit from a second power cord connected to a second output of the generator via a second receptacle; electrically isolating each received circuit by actuating a first three-pole relay associated with the first receptacle and a second three-pole relay associated with the second receptacle; combining the first and second circuits by channeling the outputs of the first and second three-pole relays to a terminal block to form a combined circuit; monitoring the hot wires from the first and second receptacles and actuating a 220/240 V coil relay only upon receiving a combined voltage of 240 V from appropriately phased hot wires, wherein the 220/240 V coil relay prevents energization of the terminal block by the combined circuit if the combined voltage is insufficient while allowing energization of the terminal block by the first circuit; and interfacing the terminal block with a house power panel line via a breaker interlock or transfer switch that controls the power feed.

In exemplary embodiments, the first and second receptacles are twist lock receptacles. Further, the first circuit is a 50 A circuit and the second circuit is a 50 A circuit so that the combined circuit is a 100 A circuit.

The method can also comprise providing proper grounding by coupling the terminal block to a ground block, with a default state of each of the first and second three-pole relays and the 220/240 V coil relay is open.

For added safety, at least one of the first and second three-pole relays can include a circuit breaker or fuse.

### DETAILED DESCRIPTION

As required, embodiments are disclosed herein; however, it is to be understood that the disclosed embodiments are merely examples and that the devices and methods described below can be embodied in various forms. Therefore, specific structural and functional details disclosed herein are not to be interpreted as limiting, but merely as a representative basis for teaching one skilled in the art to variously employ the present subject matter in virtually any appropriately detailed structure and function. Further, the terms and phrases used herein are not intended to be limiting, but rather, to provide an understandable description of the concepts.

It can be advantageous to set forth definitions of certain words and phrases used throughout this disclosure. The terms “a” or “an”, as used herein, are employed to describe elements and components described herein. This is done merely for convenience and to give a general sense of the scope of the disclosure. This description should be read to include one or at least one and the singular also includes the plural unless it is obvious that it is meant otherwise. The term plurality, as used herein, is defined as two or more than two. The term another, as used herein, is defined as at least a second or more. The term “coupled,” as used herein, is defined as “connected,” although not necessarily directly, and not necessarily mechanically.

The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, can mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items can be used, and only one item in the list can be needed. For example, “at least one of: A, B, and C” includes any of the following combinations: A; B; C; A and B; A and C; B and C; and A, B, and C.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. As used herein, the terms “substantial” and “substantially” means, when comparing various parts to one another, that the parts being compared are equal to or are so close enough in dimension that one skill in the art would consider the same. Substantial and substantially, as used herein, are not limited to a single dimension and specifically include a range of values for those parts being compared. The range of values, both above and below (e.g., “+/−” or greater/lesser or larger/smaller), includes a variance that one skilled in the art would know to be a reasonable tolerance for the parts mentioned.

Note that not all of the activities described in the general description or the examples are required, that a portion of a specific activity may not be required, and that one or more further activities can be performed in addition to those described. Still further, the order in which activities are listed is not necessarily the order in which they are performed.

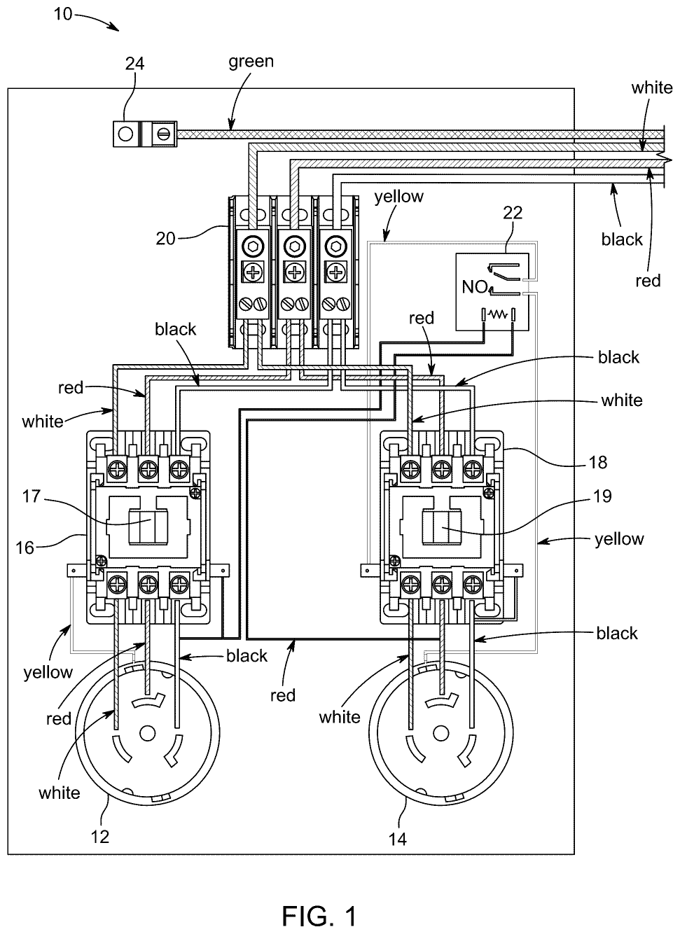

With reference to FIGS. 1-6, a dual power inlet 10 for a portable generator according to the invention safely recombines two 50-amp circuits into one 100-amp circuit for use in power backup applications. The invention contemplates that dual power inlet 10 can be used to recombine circuits having different amperages, i.e. less than or more than 50-amp. The invention also contemplates recombining more than two circuits. Moreover, the invention contemplates combining the outputs of two or more generators as discussed in more detail below.

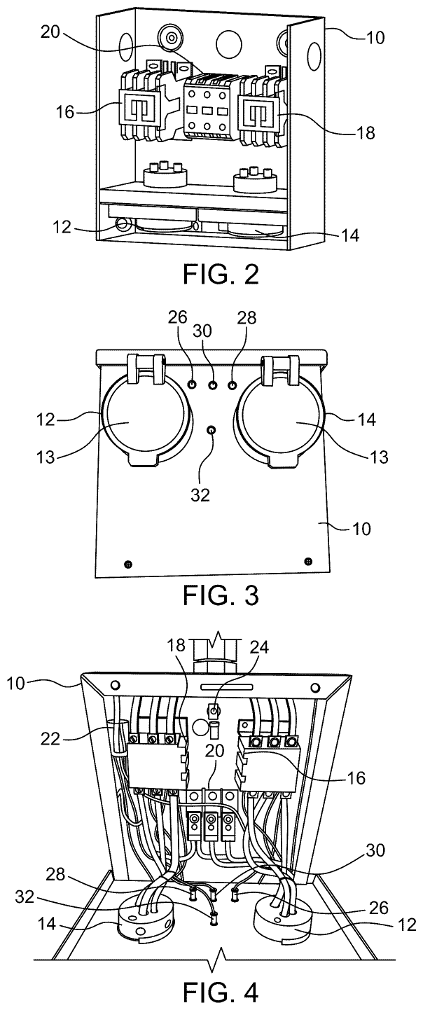

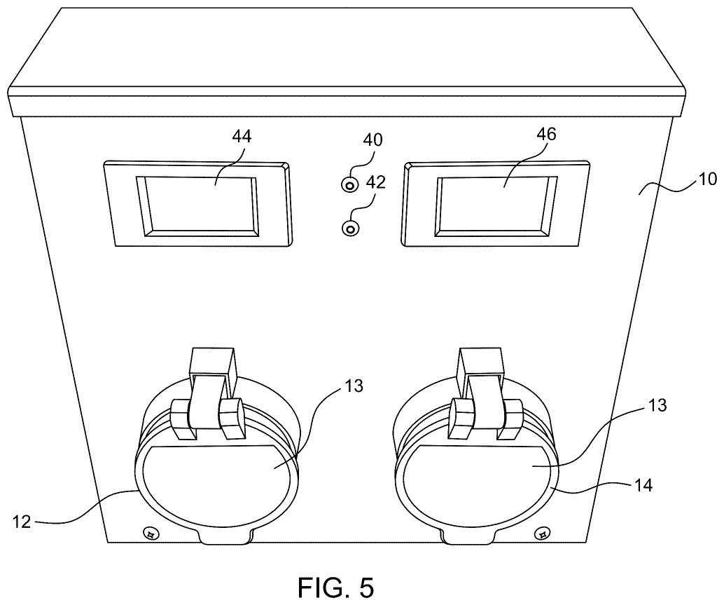

The wiring diagram is shown in FIG. 1 in which dual power inlet 10 has a first twist lock receptacle 12 for power coming from a first circuit (typically 50 A) from the output of a generator and a second twist lock receptacle 14 for power coming from a second circuit (again, typically 50 A) from the output of a generator. Instead of first twist lock receptacle 12 and/or second twist lock receptacle 14, the invention contemplates the use of any suitable receptacle. Each of receptacles 12, 14 can be provided with a cover 13 to protect the electrical connections when no plug is connected to receptacles 12, 14. Receptacles 12, 14 can be situated differently on dual power inlet 10 (compare location shown in FIGS. 3 and 5 with location shown in FIG. 2).

Electricity from the first receptacle 12 is fed into a first 120 V three pole relay 16 and electricity from the second receptacle 14 is fed into a second 120 V three pole relay 18. Three pole relays 16, 18 prevent power from feeding back into the opposite cord when connecting or disconnecting from the generator. As an additional safety measure, first three pole relay 16 and/or second three pole relay 18 can be provided with a circuit breaker or fuse. FIG. 1 shows this with first three pole relay 16 having a circuit breaker 17 and second three pole relay 18 having a circuit breaker 19.

As previously noted, the invention contemplates combining the outputs of two or more generators. In this regard, dual power inlet 10 can function as a parallel kit. When trying to parallel two inverter generators with dual power inlet 10, relays 16, 18 may tend to chatter (i.e. rapidly open and close) while the two generators attempt to synchronize, typically connecting after a few seconds. In an exemplary embodiment with two generators, dual power inlet 10 can be used with a single parallel cable between the two generators. This prevents relays 16, 18 from chattering, and allows both relays 16, 18 to quickly connect to one another, allowing the full power to pass through dual power inlet 10. One advantage of this over a conventional parallel kit is that such a parallel kit would still encounter the same 50-amp single cord barrier that dual power inlet 10 overcomes.

As both first three pole relay 16 and second three pole relay 18 feed into a terminal block 20, terminal block 20 combines the power from two separate circuits from a single generator. In the case of two 50 A circuits, a single 100 A power source results.

A 220/240 V coil relay 22 uses one 120 V hot wire from each of first and second receptacles 12, 14, creating “240 V” to trigger the normally open relay to close, thereby triggering the larger relay to close completing the circuit. If the two cords (one plugged into first receptacle 12 and the other plugged into second receptacle 14) are not matched and the hot wires are reversed, only 120 V is delivered to the small protection relay. This will not trigger the relay to close, thereby not allowing the larger relay to activate preventing a short circuit condition. As an additional safety measure, the line from first receptacle 12 and/or second receptacle 14 to coil relay 22 can be provided with a fuse or circuit breaker.

If no fault is detected, power is fed out from terminal block 20 to house power panel line. The hot legs from terminal block 20 are connected to a breaker controlled by an interlock or a transfer switch. A ground block 24 is included for proper grounding. As noted below, the present invention contemplates modification to comply with safety (e.g. UL regulations and/or local electrical code) requirements.

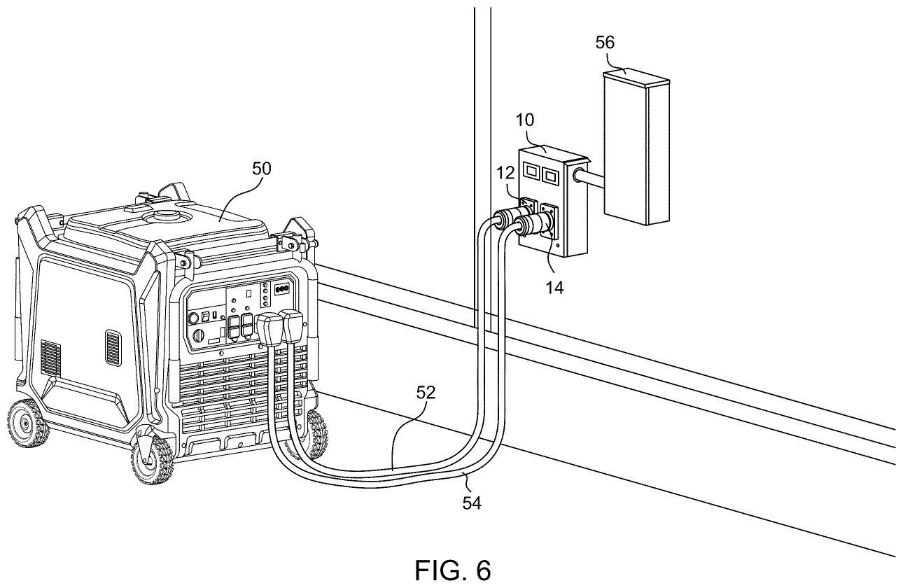

FIG. 6 shows a generator 50 has dual outlets with a first power cord 52 connected to one outlet and a second power cord 54 connected to the other outlet. The other end of first power cord 52 is connected to receptacle 12 of dual power inlet 10 and the other end of second power cord 54 is connected to receptacle 14 or dual power inlet 10. Terminal block 20 (not visible in FIG. 6) of dual power inlet 10 connects to a transfer switch 56 or directly to an interlock in the house main power service panel or sub panel.

Dual power inlet 10 addresses several problems as will now be discussed.

A first problem is that there are no commercially available power outlets or cords that consumers can use that will handle over 50 amps for combining the output circuits of a generator. There are some very large and expensive systems used by the military, heavy industry, and commercially for large events like rock concerts, but these systems are not practical for this application. The present invention overcomes this problem by using two 50 A power cords that can be readily purchased at local hardware stores or online. The two cords can be combined to deliver larger loads safely to the home. In the case of two 50 amps, the larger load is 100 amps, but the present invention contemplates even higher amperage.

A second problem is the challenge to recombine the divided power circuits safely. Although one could easily just combine the circuits together in the inlet box, once the two cords are connected to the inlet, they create a loop. If you disconnect one of the power cords, you will have exposed energized conductors at the male end that could be lethal on contact. The present invention overcomes this hazard by using two relays, one for each power cord inlet. Simply disconnecting the plug from the outlet breaks the circuit by opening the relay to its default state normally open, thus shutting off the power breaking the power loop. As this works the same for both sides, removing the power makes the cord ends safe to handle.

A third problem is the possibility of crossed load lines. 240 V single-phase power relies on a single split phase with two hots wires each carrying 120 V at 180 degrees out of phase from each other to produce a 240 V circuit. Most cords from the same manufacturers are matched and work fine together. In the event a pair of unmatched cords are used, the present invention will prevent them from combining incorrectly and preventing damage from occurring. If the wires are combined incorrectly “usually a red and black” it creates a short circuit condition. This short circuit condition can blow the breaker and damage the generator's power circuits.

The present invention solves this by using a third relay, i.e. 220/240 V coil relay 22. The present invention uses one 120 V hot wire from each side creating “240 V” to trigger the normally open relay to close triggering the larger relay to close completing the circuit. If the two cords are not matched and the hot wires are reversed it delivers only 120 V total to the small protection relay, this will not trigger the relay, not allowing the larger relay to activate preventing a short circuit condition.

The present invention also allows the dual inlet to be safely used with a single cord. When the single cord is connected it allows 50 amps of power to pass through the inlet box, the opposite inlet will not be energized so there is no chance someone opening the cover and being electrocuted by touching the exposed conductors.

As shown in FIG. 3, four indicator lights let the user know the state of the inlet. The first two lights (26, 28) indicate there is power present as each cord is connected. The third light (30) indicates that the two cords are in synch and is ready to use. The last light (32) warns that the cords are out of synch and cannot be used together. Thanks to inlet 10, this state is not dangerous, as the protection relay prevents any damage and inlet 10 will only carry the load from first receptacle 12 even though second power cord 54 is receiving power from generator 50.

FIG. 5 shows another embodiment, which has indicator lights and meters. In particular, two indicator lights (40, 42) let the user know the state of the inlet, i.e. first receptacle 12 and second receptacle 14. Amp meters 44, 46 will power on independently as each of first receptacle 12 and second receptacle 14 is energized, indicating that power is present, if only one cord is energized you will only have one amp meter showing readings and no indicator lights. After energizing the second cord the other amp meter will light up and one of the two indicator lights will light up.

Scenario one—If the two circuits are matched, a green indicator light signifies they are in sync and the full power through the combined cords is available.

Scenario two—If both energized cords are connected, a red indicator light signifies that the cords are not matched and are out of sync. Because of the features of device 10, this state will not cause any harm or damage to anything (inlet box, cords, load circuit or the generator), but only provides power from one of the receptacles. The other receptacle will not energize the small protection or main relay, resulting in no circuit being created. The amp meter remains on indicating power is connected. One last item to be noted, all relays in this design are normally open by default, adding another layer of safety to the design.

All references cited herein are expressly incorporated by reference in their entirety. It will be appreciated by persons skilled in the art that the invention is not limited to what has been particularly shown and described herein above. In addition, unless mention was made above to the contrary, it should be noted that all of the accompanying drawings are not to scale. There are many different features to the invention and it is contemplated that these features may be used together or separately. Thus, the invention should not be limited to any particular combination of features or to a particular application of the invention. Further, it should be understood that variations and modifications within the spirit and scope of the invention might occur to those skilled in the art to which the invention pertains. Accordingly, all expedient modifications readily attainable by one versed in the art from the invention set forth herein that are within the scope and spirit of the present invention are to be included as further embodiments of the invention.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function.

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, sacrosanct or an essential feature of any or all the claims.

After reading the disclosure, skilled artisans will appreciate that certain features are, for clarity, described herein in the context of separate embodiments, can also be provided in combination in a single embodiment. Conversely, various features that are, for brevity, described in the context of a single embodiment, can also be provided separately or in any sub-combination. Further, references to values stated in ranges include each and every value within that range.

The above discussion is meant to be illustrative of the principles and various embodiments of the present invention. Numerous variations and modifications will become apparent to those skilled in the art once the above disclosure is fully appreciated.

1. An apparatus for safely recombining split power output from a portable electric generator, the apparatus comprising:
a first receptacle configured to receive a first power cord delivering a first electrical power from a first output of the portable electric generator;
a second receptacle configured to receive a second power cord delivering a second electrical power from a second output of the portable electric generator;
a first three-pole relay electrically coupled to the first receptacle for preventing reverse current flow;
a second three-pole relay electrically coupled to the second receptacle for preventing reverse current flow;
a terminal block electrically connected to the first and second three-pole relays for combining the first and second electrical power from the first and second power cords to provide a combined electrical power output equal to a sum of the first and second electrical power; and
a 220/240 V coil relay electrically connected to the first and second receptacles via respective hot wires, the 220/240 V coil relay being configured to actuate only upon receiving a combined voltage of 240 V when the hot wires are appropriately phased,
wherein the combined electrical power output flows through the terminal block when the 220/240 V coil relay is actuated and only one of the first and second electrical power flows through the terminal block when 220/240 V coil relay is not actuated.

2. The apparatus of claim 1, wherein the first and second receptacles are twist lock receptacles.

3. The apparatus of claim 2, wherein the first electrical load is a 50 A circuit and the second electrical load is a 50 A circuit so that the combined electrical power output is a 100 A power output.

4. The apparatus of claim 3, further comprising a ground block configured for providing proper grounding for the apparatus and wherein a breaker interlock or a transfer switch is operatively coupled between the terminal block and a house power panel.

5. The apparatus of claim 4, wherein a default state of each of the first and second three-pole relays and the 220/240 V coil relay is open.

6. The apparatus of claim 1, wherein at least one of the first and second three-pole relays includes a circuit breaker or fuse.

7. A method for safely recombining split power output from a portable generator, the method comprising:
receiving a first circuit from a first power cord connected to a first output of the generator via a first receptacle;
receiving a second circuit from a second power cord connected to a second output of the generator via a second receptacle;
electrically isolating each received circuit by actuating a first three-pole relay associated with the first receptacle and a second three-pole relay associated with the second receptacle;
combining the first and second circuits by channeling the outputs of the first and second three-pole relays to a terminal block to form a combined circuit;
monitoring the hot wires from the first and second receptacles and actuating a 220/240 V coil relay only upon receiving a combined voltage of 240 V from appropriately phased hot wires, wherein the 220/240 V coil relay prevents energization of the terminal block by the combined circuit if the combined voltage is insufficient while allowing energization of the terminal block by the first circuit; and
interfacing the terminal block with a house power panel line via a breaker interlock or transfer switch that controls the power feed.

8. The method of claim 7, wherein the first and second receptacles are twist lock receptacles.

9. The method of claim 8, wherein the first circuit is a 50 A circuit and the second circuit is a 50 A circuit so that the combined circuit is a 100 A circuit.

10. The method of claim 9, further comprising providing proper grounding by coupling the terminal block to a ground block.

11. The method of claim 9, wherein a default state of each of the first and second three-pole relays and the 220/240 V coil relay is open.

12. The method of claim 7, wherein at least one of the first and second three-pole relays includes a circuit breaker or fuse.
